(19) United States
(12) Patent Application Publication
(10) Pub. No.: US 2016/0083940 A1
(43) Pub. Date: Mar. 24, 2016

(54) BALANCING CONTROL VALVE FOR FAUCET

(71) Applicant: Hsiang-Shih Wang, Changhua (TW)

(72) Inventor: Hsiang-Shih Wang, Changhua (TW)

(73) Assignee: GEANN INDUSTRIAL CO.,LTD., CHANGHUA (TW)

(21) Appl. No.: 14/492,021

(22) Filed: Sep. 21, 2014

(51) Int. Cl. E03C 1/04; F16K 47/04; F16K 11/06

(52) U.S. Cl. CPC E03C 1/04; F16K 11/06; F16K 47/04; E03C 2001/026

(57) ABSTRACT

A ceramic balancing control valve of a faucet includes a fixed valve pipe, a movable spool, two flow covers and two caps. The fixed valve pipe has a through hole, and each side of the pipe body engraves a conduction gap communicating with the through hole. The movable spool is located inside the through hole of the fixed valve pipe, and each side thereof has a concave groove compartment separated by a partition. Two flow covers are facing each other, and a flow channel is formed on an upper and lower portion of the flow cover corresponding to the conduction gap of the fixed valve pipe; and each caps has at least one circulation hole, and is located at an upper portion of the flow channel, so the water flowing into the flow cover is configured to flow out of the cap from circulation hole.

### FIELD OF THE INVENTION

The present invention relates to a structure of a ceramic balancing control valve of a faucet, especially for a ceramic balancing control valve to prevent excessive pressure difference.

### BACKGROUND OF THE INVENTION

To avoid the instability of water pressure caused by cold or hot running water, which results in fluctuation of the water temperature, therefore a balancing valve is installed in the ceramic control valve of the faucet. The structure is composed of a fixed valve pipe, with a movable spool in it. There are a few sets of gaskets within the body of the fixed valve pipe. Each side of the pipe body engraves a conduction gap. Each side has a concave groove compartment; the concave groove compartments are separated by a partition. A conduction gap is installed at each of the interior part of the concave groove compartment, so that the movable spool can be adjusted when there is a change of cold and hot water pressure, thereby changing the corresponding conduction gap of the movable spool and the fixed valve pipe to achieve automatic balancing of hot and cold water temperature; However, when the balancing valve is in use, the strong currents will run directly from the corresponding conduction gap of the movable spool and the fixed valve pipe into the ceramic control valve, and a great pressure difference will be formed between the ceramic control valve and the balancing valve. The pressure will cause the rapid displacement of the movable spool and produce a great deal of noise. When the movable spool is often in a highly active collision under the displacement, it is also likely to cause damages to those counterparts.

Therefore, there remains a need for a new and improved balancing control valve of a faucet to overcome the problems stated above.

### SUMMARY OF THE INVENTION

When the conventional balancing valve is in use, the strong currents will run directly from the corresponding conduction gap of the movable spool and the fixed valve pipe into the ceramic control valve, and a great pressure difference will be formed between the ceramic control valve and the balancing valve. This is the problem that needs to be solved.

The present invention provides a structure of the faucet's ceramic balancing control valve, which includes a fixed valve pipe, a movable spool, two flow covers and two caps, which the fixed valve pipe has a consistently axial through hole. Each side of the pipe body engraves a conduction gap by formation with the through hole. A ring groove is set at the exterior of the conduction gap on the fixed valve pipe, and a sealing ring is provided on the ring groove. The movable spool is located inside the through hole of the fixed valve pipe. Each side has a concave groove compartment; the concave groove compartments are separated by a partition, and each side has a grooving tool that corresponds to the conduction gap in the second concave groove compartment. The two flow covers are facing the same setting, on the inside has a flow channel, in order to cover the fixed valve pipe of the balancing valves. On the upper and lower part, each has a flow channel, and the flow tube corresponds to a conduction gap of the fixed valve pipe. The outside of the two caps each provided with at least one circulation hole on the top of the caps combined with the flow tube, so that the inflow of water can change the outflow from circulation hole through the caps. Therefore, a structure of the faucet's ceramic balancing control valve can be obtained.

Comparing with prior arts, the present invention is advantageous because (i) the present invention provides a structure of the faucet's ceramic balancing control valve. When the cold and hot water is imported from the flow covers, it will first be blocked by the caps. After a water room is accumulated inside the flow covers, the reduction of water will flow from the circulation hole. It is served to prevent a large water flow from directly being poured into the ceramic control valve, which will form a large pressure difference between the ceramic control valve and the balancing valve; and (ii) the present invention provides a structure of the faucet's ceramic balancing control valve, which utilizes the set up of caps to reduce hot and cold water flow from the circulation hole. It can prevent the forming of excessive pressure between the ceramic control valve and the balancing valve. Therefore when it is in use, it does not generate great noise brought by the rapid displacement of the movable spool, it can also prevent excessive collision of the movable spool that accelerates the damage to the counterparts.

### BRIEF DESCRIPTION OF THE DRAWINGS

FIG. 1 illustrates a three-dimensional view in the present invention.

FIG. 2. illustrates an exploded view of the balancing valve in the present invention.

FIG. 3 illustrates a two-dimensional view in the present invention.

FIG. 4 is a perspective view of the frame body in the present invention.

FIG. 5 is an exploded view of the frame body in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

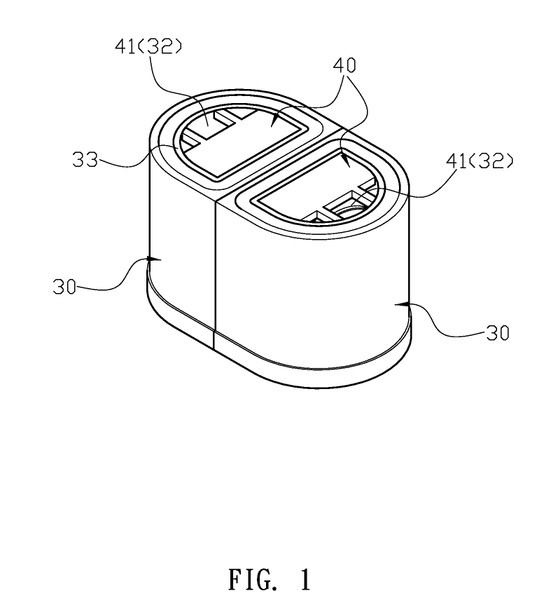

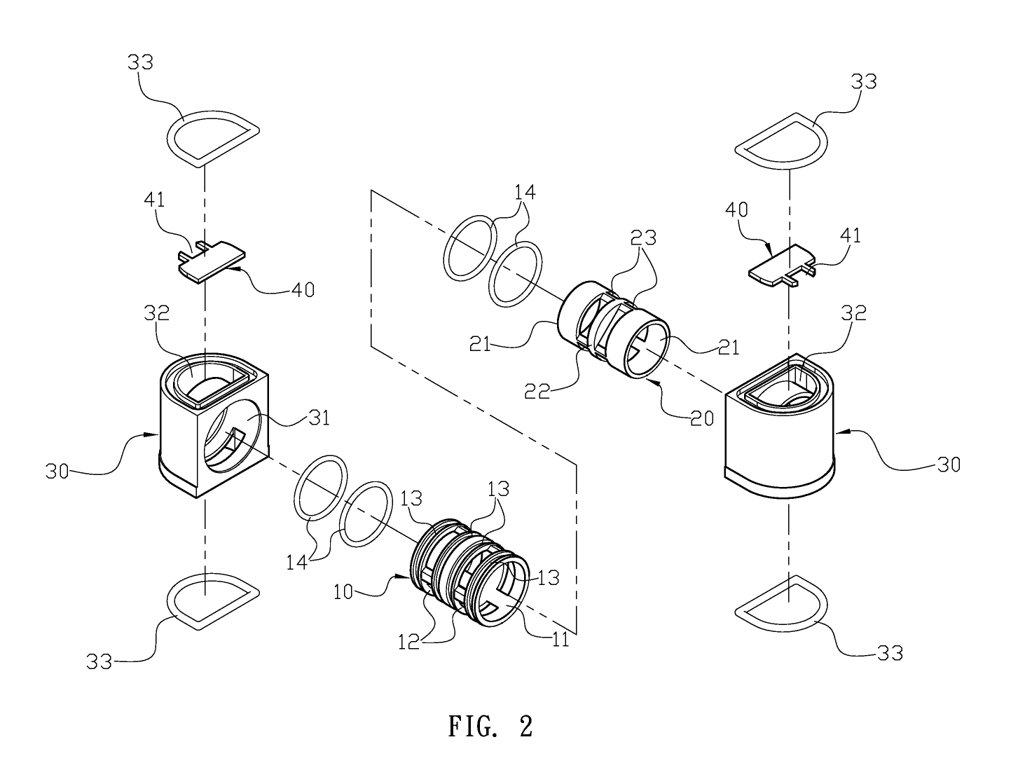

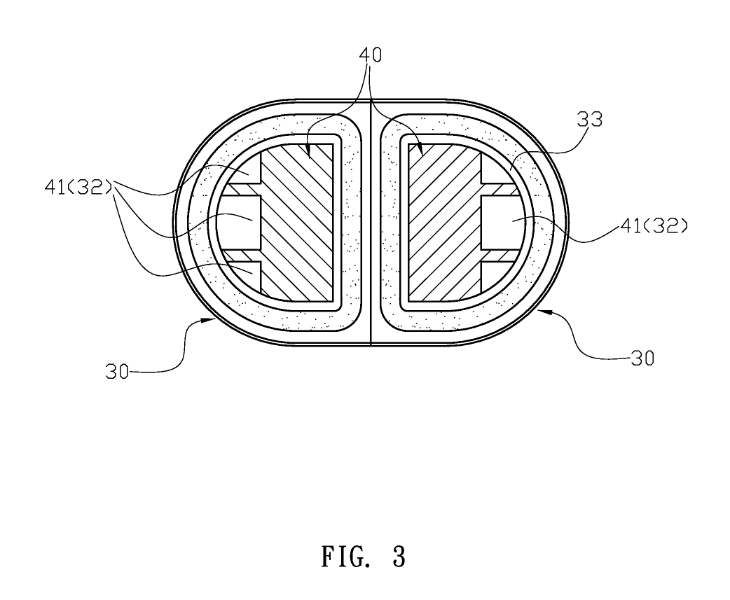

Referring to FIGS. 1 to 3, the present invention provides a structure of the faucet's ceramic balancing control valve, which may include, a fixed valve pipe (10), a movable spool (20), two flow covers (30) and two caps (40), which the fixed valve pipe (10) has a consistently axial through hole (11). Each side of the pipe body engraves a conduction gap (12) by formation with the through hole (11). A ring groove (13) is set at the exterior of the conduction gap (12) on the fixed valve pipe (10), and a sealing ring (14) is provided on the ring groove (13). The movable spool (20) is located inside the through hole (11) of the fixed valve pipe (10). Each side has a concave groove compartment (21); the concave groove compartments (21) are separated by a partition (22), and a conduction gap (12) of grooving a corresponding groove (23) in the second concave groove compartment (21) of each side. The two flow covers (30) are facing the same setting, on the inside has a flow channel (31), in order to cover the fixed valve pipe (10) of the balancing valves. On the upper and lower part, each has a flow channel (31), and the flow tube (32) corresponds to a conduction gap (12) of a fixed valve pipe (10). The outside of the two caps (40) each provided with at least one circulation hole (41) on the top of the caps (40) combined with the flow tube (32), so that the inflow of water can change the outflow from circulation hole (41) through the caps (40).

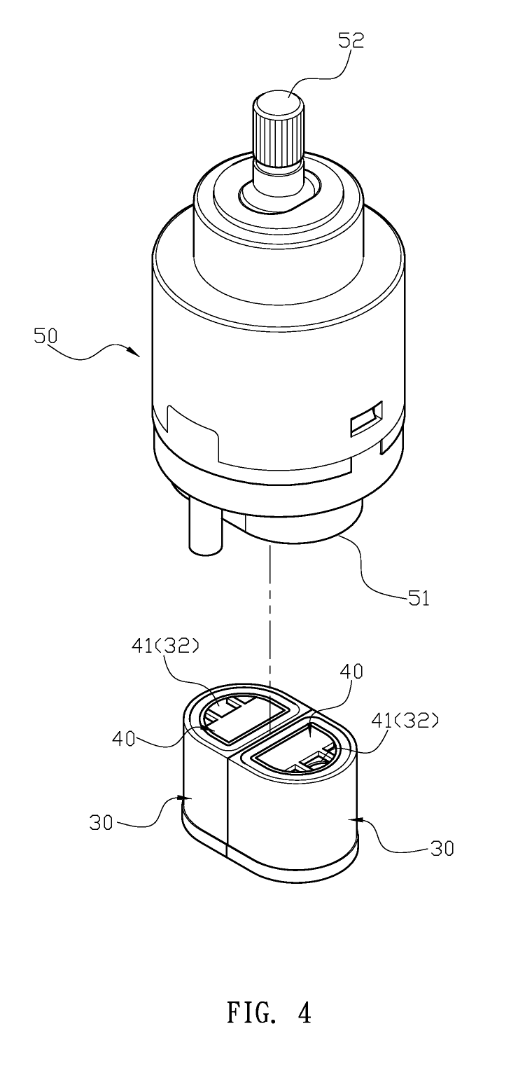

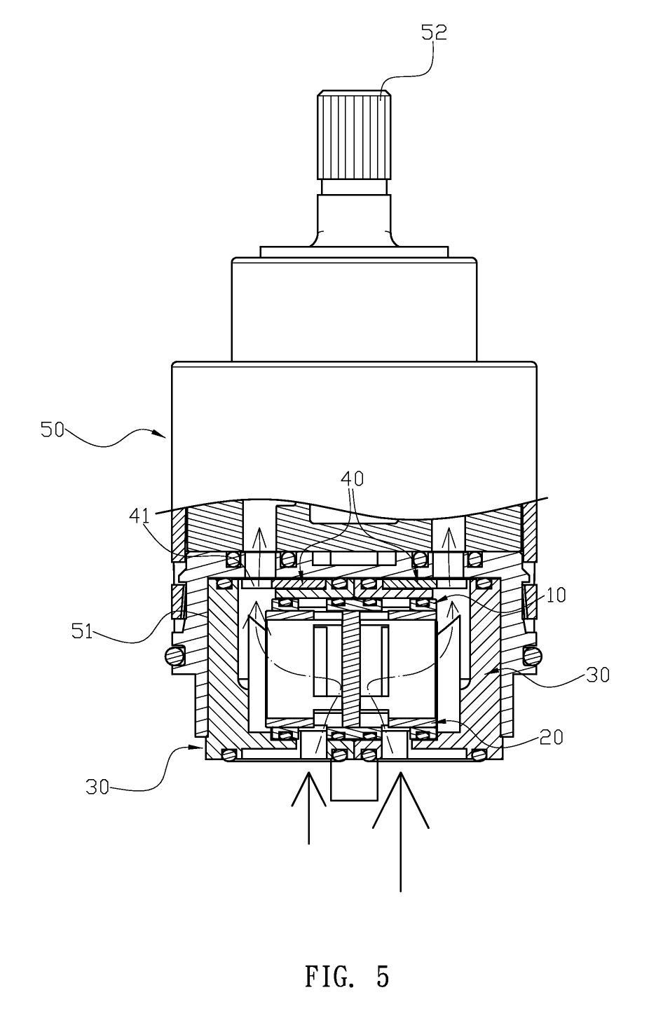

Referring to FIGS. 4 and 5, when it is actually in use, the balancing valve utilises said two flow covers (30) and put it into the reserved room (51) of the ceramic control valve (50). It is served to operate the control shaft bolt (52) of the ceramic control valve. After the switching of the interior of the ceramic sheet, it can be used to control the opening and closing of water flow, or change the mixed size of cold and hot water. The hot and cold water is imported from the flow covers (30) in order to make use of the balancing valve to stabilize the water pressure of both sides, and then from the flow tube (32) through the caps (40) of the circulation hole (41) into the ceramic control valve (50). When the cold and hot water is imported from the flow covers (30), it will first be blocked through the caps (40). After a water room is accumulated inside the flow covers (30), the reduction of water will flow from the circulation hole (41). It is served to prevent a large water flow from directly being poured into the ceramic control valve (50), which will form a large pressure difference between the ceramic control valve (50) and the balancing valve. Therefore it does not generate great noise brought by the rapid displacement and excessive collision of the movable spool.

In another embodiment, the top and bottom part of the flow tube (32) are set with a gasket (33) at the top and bottom surface of the flow covers (30).

Comparing with prior arts, the present invention is advantageous because (i) when the cold and hot water is imported from the flow covers (30), it will first be blocked by the caps (40). After a water room is accumulated inside the flow covers (30), the reduction of water will flow from the circulation hole (41). It is served to prevent a large water flow from directly being poured into the ceramic control valve (50), which will form a large pressure difference between the ceramic control valve (50) and the balancing valve; and (ii) the present invention utilizes the set up of caps (40) to reduce hot and cold water flow from the circulation hole (41), which can prevent excessive pressure between the ceramic control valve (50) and the balancing valve. Therefore when it is in use, it does not generate great noise brought by the rapid displacement of the movable spool (20), and it can also prevent excessive collision of the movable spool (20) that accelerates the damage to the counterparts.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A ceramic balancing control valve of a faucet comprising: a fixed valve pipe, a movable spool, two flow covers and two caps, wherein the fixed valve pipe has a through hole, and each side of the pipe body engraves a conduction gap communicating with the through hole; the movable spool is located inside the through hole of the fixed valve pipe, and each side thereof has a concave groove compartment separated by a partition, and each sidewall of the groove compartment has a slot corresponding to the conduction gap; the two flow covers are facing each other, and each has a receiving slot to secure the fixed valve pipe of the balancing valves, and a flow channel is formed on an upper and lower portion of the flow cover corresponding to the conduction gap of the fixed valve pipe; and each caps has at least one circulation hole, and is located at an upper portion of the flow channel, so the water flowing into the flow cover is configured to flow out of the cap from circulation hole.

2. The ceramic balancing control valve of a faucet of claim 1, wherein a ring grove is formed at an outer portion of the conduction gap, and a sealing ring is provided for said ring grove.

3. The ceramic balancing control valve of a faucet of claim 1, wherein the circulation hole is formed at an outer portion of the caps.

4. The ceramic balancing control valve of a faucet of claim 1, wherein a gasket is disposed at a top and bottom portion of the flow cover corresponding to a top and bottom portion of the flow channel.

5. The ceramic balancing control valve of a faucet of claim 1, wherein the balancing valve is operated with a ceramic control valve that receives two flow covers in a receiving space therein, so a control shaft of the ceramic control valve is used to control the water flow, or the amount of cold and hot water.
